(19) United States
(12) Patent Application Publication
(10) Pub. No.: US 2024/0247542 A1
(43) Pub. Date: Jul. 25, 2024

(54) DISPLACEABLE WAND WITH CHAIN RESTRICTOR

(71) Applicant: MAXXMAR INC., Toronto (CA)

(72) Inventor: Mario Marocco, Toronto (CA)

(21) Appl. No.: 18/101,488

(22) Filed: Jan. 25, 2023

(51) Int. Cl. E06B 9/326

(52) U.S. Cl. CPC E06B 9/326; E06B 2009/3225

(57) ABSTRACT

A displaceable wand, comprising; an elongated member extending from a first end to a second end, an endless loop blind control element disposed within said elongated member and extending beyond at least one of the first and second ends; and a restrictor presented at one of the first and second ends, the restrictor extending through said endless loop blind control element to permit the elongated member to:
a) hang from said endless loop blind control element and block access to the one end of the endless loop blind control element in a first position, and;
b) be raised to a second position to expose said one end of the endless loop blind control element and rotate the endless loop blind control element in the second position.

### FIELD OF INVENTION

This invention relates to a displaceable wand with an endless loop blind control element comprising an elongated member extending from a first end to a second end, said endless loop blind control element disposed within said elongated member and extending beyond said first and second end, and a restrictor presented at one of said first and second ends and extending through said endless loop blind control element to permit said displaceable wand to hang from said endless loop blind control element in a first position and permit rotation of said endless loop blind control element in a second position.

### BACKGROUND OF THE INVENTION

Blinds for building openings, such as windows, doors and the like, may be operated either simply down and up, in the case of e.g. roller blinds, or in the case of for example vertical shade panels, the vertical shade panels may be rotated open or closed.

The control elements for these blind operations are usually in the form of an endless cord or chain. The control element simply hangs down along one side of the building opening, in an endless loop.

Other forms of blinds and window coverings may also be operated by means of an endless control element hanging in a loop.

In the past this system has been widely used, and experience was believed to be mainly satisfactory. In some cases a pendant weight was located on the loop, to assist in controlling it.

U.S. Pat. No. 4,932,456, inventor G Buxbaum, shows the usual form of blind chain and drive sprocket gear on the blind roller such as being standard in the art.

However safety considerations for some time have been forcing Government agencies seek further ways to restrict unsafe or unwanted access to the endless loop type of control element. The intent of these considerations has been mainly to prevent any chance that the element may possibly create a hazard to children, or handicapped persons, or even pets.

In addition, by guiding and controlling the loop of the element, its operation by anyone becomes somewhat easier. The element is prevented from becoming twisted, or entangled with any other blinds controls, curtains or the like.

The prior art includes US 2019/0195014

### SUMMARY OF THE INVENTION

It is an aspect of this invention to provide a displaceable wand, comprising; an elongated member extending from a first end to a second end, an endless loop blind control element disposed within said elongated member and extends beyond at least one of the first and second ends; and a restrictor presented at one of the first and second ends, the restrictor extending through the endless loop blind control element to permit said elongated member to:
a) hang from the endless loop blind control element and block access to the one end of the endless loop blind control element in a first position, and;
b) be raised to a second position to expose the one end of said endless loop blind control element and rotate the endless loop blind control element in a second position.

In one embodiment the first and second ends comprise an upper end and a lower end respectively and the restrictor is positioned at said lower end.

In another embodiment the elongated member comprises a tube, where for example the tube is selected from the group having a rectangular, circular, oval, poly-sided and transparent cross section.

In one embodiment the endless loop blind control member hangs from a blind control adjacent the upper end of the tube. The blind control includes either a sprocket, clutch or pulley and the endless loop blind control element hangs from the sprocket, clutch or pulley.

In one embodiment the restrictor is fastened to the lower end of the tube. The restrictor has an open restrictor end having the same cross-section as the lower end of the tube and a transit end having two transit openings separated by an abutment to permit the endless loop blind control element to transit around the lower end of the wand. In one embodiment the abutment has a curved surface.

In another embodiment the wand includes a least one magnetic member disposed between the upper and lower ends of the tube; wherein the wand hangs substantially vertical to a window frame and the window frame includes a magnetic metal adjacent the magnetic member for magnetic attraction there between.

In another embodiment the wand hangs substantially vertical to a window frame and the window frame includes a tensioning device traversed by a lower end of the endless loop blind control element to keep the endless loop blind control element in tension. The tensioning device includes a flap that is moveable between an open position to insert said lower portion of said endless loop blind control element into said tensioning device and a closed position. The tensioning device can include a socket opening to engage with a hand crank to rotate said endless loop blind control element.

In another embodiment the wand hangs substantially vertical to a window frame and the window frame includes a retainer to retain the wand against the window frame in the vertical position.

In a further embodiment up to 8 inches or 20 centimeters of the lower end of the endless loop blind control element is exposed in said second position.

In yet another embodiment the tube includes a first magnetic member at the lower end and a second magnetic member at the upper end.

In another embodiment the elongated member includes an upper guide presented at the upper end of the elongated member for guiding the endless loop blind control element.

The endless loop blind control element comprises a cord having spaced beads disposed along the cord and the curved surface is longer than the distance between said spaced beads.

In one embodiment the tube is rectangular in cross section and transparent.

In another embodiment displaceable wand comprises an elongated transparent tube extending from an upper end to a lower end; an endless loop blind control element disposed within said transparent tube and extending beyond said upper and lower end of said elongated transparent tube; an abutment at said lower end of said tube extending through said endless loop blind control element to permit said elongated transparent tube to:
a) hang from a lower end of said endless loop blind control element and block access to said lower end of said endless loop blind control element in a first position, and;
b) be raised to a second position to expose said lower end of said endless loop blind control element and manually rotate said endless loop blind control element in said second position.

These and other features of the invention shall now be described in relation to the following drawings.

### SUMMARY OF DRAWINGS

FIG. 1 is a perspective view of the wand for operating a window fabric of a window blind or shade in a first closed position.

FIG. 2 is a perspective view of the wand for operating a window fabric of a window blind or shade in a second operable position.

FIG. 3 is a front elevation view of the wand of FIG. 1 in the first closed position.

FIG. 4 is a front elevation view of the wand which is pulled to the side showing magnets.

FIG. 5 is a side elevation view of the wand having magnets and where the wand pulled away from the frame of a window and manipulated by raising the wand to a second raised operable position.

FIG. 6 is a front elevation view of FIG. 5.

FIG. 7 is a side elevation view of the wand where the wand is pulled away from the frame of a window and manipulated by lowering the wand to a first lower position.

FIG. 8 is a front elevation view of FIG. 7.

FIG. 9 is a side elevation view of the wand with a clip where the wand is in a second operable position.

FIG. 10 is a side elevation view of the wand with a clip where the wand is in a first closed position.

FIG. 11 is a front elevation view of the wand with a tensioner with the wand in the first closed position.

FIG. 12 is a side elevation view of the wand with a tensioner with the wand in the first closed position.

FIG. 13 is a front elevation view of the wand with a tensioner with the wand in the second operable position.

FIG. 14 is a side elevation view of the wand with a tensioner with the wand in the second operable position.

FIG. 15 is a front elevation view of the wand with a tensioner with the wand in the second operable position showing a hand crank.

FIG. 16 is a side elevation view of the wand with a tensioner with the wand in the second operable position showing a hand crank.

FIG. 17 is a perspective view of the wand with a tensioner and hand crank.

### DETAILED DESCRIPTION OF THE INVENTION

Like parts are given the same number throughout the drawings.

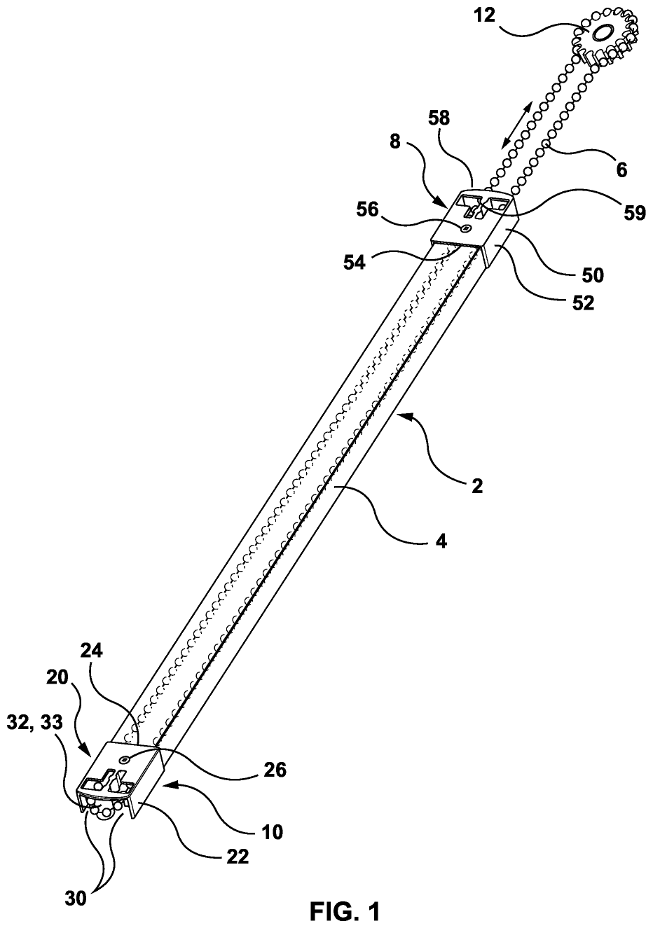

FIG. 1 is a perspective view of a wand 2 for operating a window fabric of a window blind or shade. The wand 2 comprises an elongated member 4 which in one embodiment is a tube having a rectangular cross-section. The elongated member 4 extends from a first or upper end 8 to a second or lower end 10. Other cross-sections can be used such as circular, oval, square or poly-sided. The elongated body can be made of suitable material such as plastic or the like. In the embodiment shown the elongated member is transparent.

An endless loop blind control element 6 is disposed within the elongated member 4 and extends beyond at least one of the first or upper end 8 and second or lower ends 10. The endless loop blind control element can consist of a cord, balls spaced along a cord in a manner well known to those persons skilled in the art relating to window blinds or shades.

The endless loop blind control element extends 6 beyond the upper end 8 of elongated member 4 to “hang from” and engage with a sprocket 12 of a blind control. The sprocket 12 can be part of a clutch control 14 in a typical window blind or shade. The clutch control 14 is located in a housing 15 having a clutch housing opening 17 to receive a portion of the endless loop blind control element 6. Instead of a sprocket a pulley can be used.

The wand 2 includes a restrictor 20 or support at the lower end 10 of the elongated member 4. The restrictor 20 can be integral with the elongated member 4 or alternatively as shown can consist of a separate restrictor body 22 having an open restrictor end 24 which has the same cross section as the lower end 10 of elongated member 4 so as to telescope therein. In one embodiment the restrictor body 22 is fastened to the lower end of elongated member 4 by a screw 26 or other suitable fastening means such as an adhesive. The restrictor body 22 has a transit end 28 opposite the open restrictor end 24. The transit end 28 has two transit openings 30 separated by an abutment or support surface 32 to permit or accommodate the endless loop blind control element to transit around the lower end 10 of the elongated member 4 of the wand 2.

The abutment 32 has a curved surface 33 that contacts the endless loop blind control element 6. The curved surface 33 is longer than the distance between the spaced beads of the endless loop blind control element 6 so that the endless loop blind control element rotates around the abutment 32 smoothly without any substantial snags. The abutment 32 can extend or project beyond the transit end 28 or alternatively the abutment 32 can be positioned within the restrictor body 22. Alternatively the abutment may be part of the lower end of the elongated member or inside the lower end of the tube 4.

The upper end 8 of the elongated member 4 includes a guide 50. The guide 50 can be integral with the elongated member 4 or alternatively as shown can consist of a separate guide body 52 having an open guide end 54 which has the same cross section as the upper end 8 of elongated member 4 so as to telescope therein. In one embodiment the guide body 52 is fastened to the upper end of elongated member 4 by a screw 56 or other suitable fastening means such as an adhesive. The guide body 52 has a guide transit end 58 opposite the guide end 54. The guide transit end 58 has two transit openings 50 separated by support surface 59 to permit or accommodate the endless loop blind control element 6 to transit through the upper end 8 of the elongated member 4 of the wand 2.

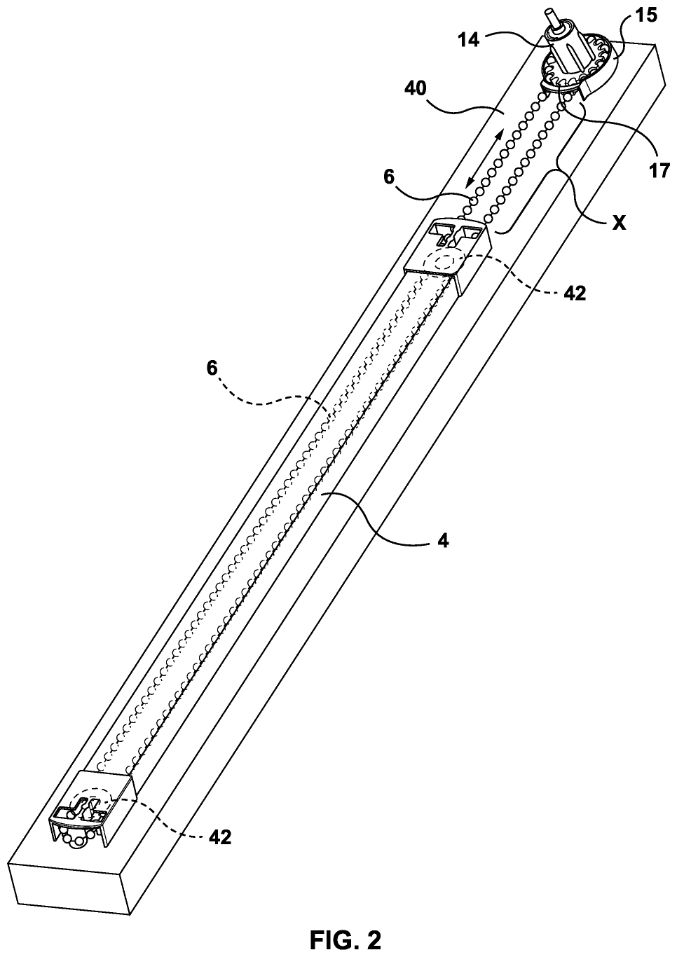

The wand 2 hangs from a socket 12 or clutch assembly 14 of a window blind adjacent a frame 40 of a window shown in FIG. 2. The wand 2 in one embodiment includes at least one magnetic member 42 disposed between the upper end 8 and lower end 10 and the window frame 40 also includes at least one magnetic metal 44 that is attracted to the magnetic member 42 for magnetic interaction there between when the wand 2 ‘hangs” substantially vertically from the sprocket 12 or clutch assembly 14 due to gravity. In one embodiment there is one magnetic metal 44 adjacent the lower end 10 of wand 2. The strength of the magnet can be selected to make it difficult for a child to separate the wand 2 or magnetic member 42 from the magnetic metal 44. This acts as an added level of child proofing the wand 2. In another embodiment there can be two magnetic metals 44 at the frame 40 adjacent the upper end 8 and lower end 10 of the wand 2.

The magnetic material 42 can be secured to the wand by a fastener 50 or adhesive such as a screw 50. The magnetic metal 44 can be a metal washer 52 or the like that is secured to the frame 40 by a screw or by adhesive. In one embodiment the magnetic material 42 is fastened to the restrictor body 22 such as a screw or fastener, or adhesive.

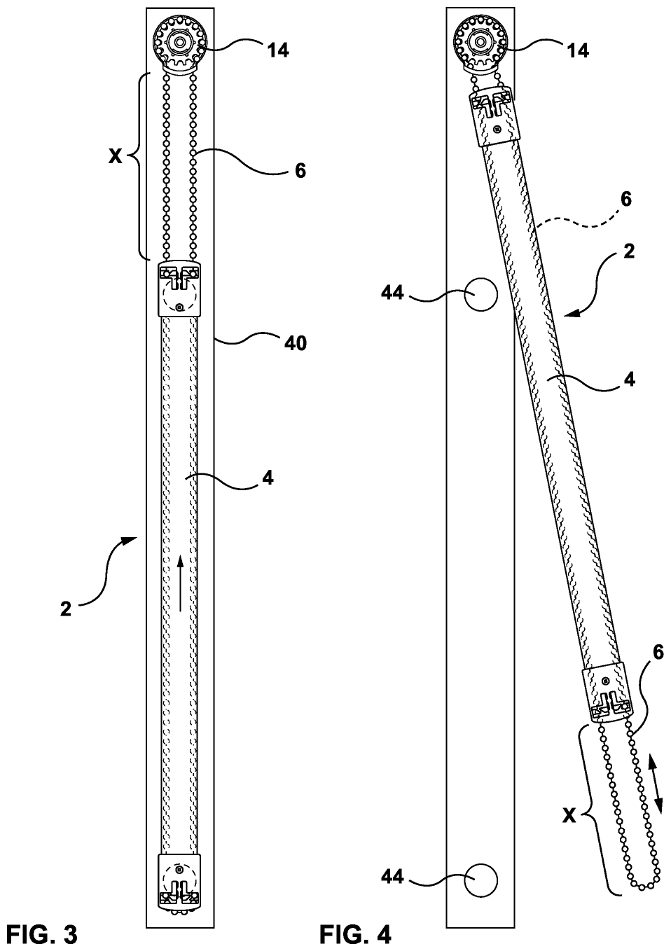

The restrictor 20 and in particular the abutment or support surface 32 extends through the endless loop blind control element 6 to permit the elongated member 4 to:
a) hang from said endless loop blind control element 6 and block access to the lower end 10 of the endless loop blind control element 6 in a first or lower position, as shown in FIG. 4 and;
b) be raised to a second or open position to expose the lower end of said endless loop blind control element 6 and rotate said endless loop blind control element in said second or operable position as shown in FIG. 3.

In particular the abutment or support surface 32 bears against or contacts the lowest part of the endless loop blind control element 6 and prevents the wand 2 and elongated member 4 to drop any further.

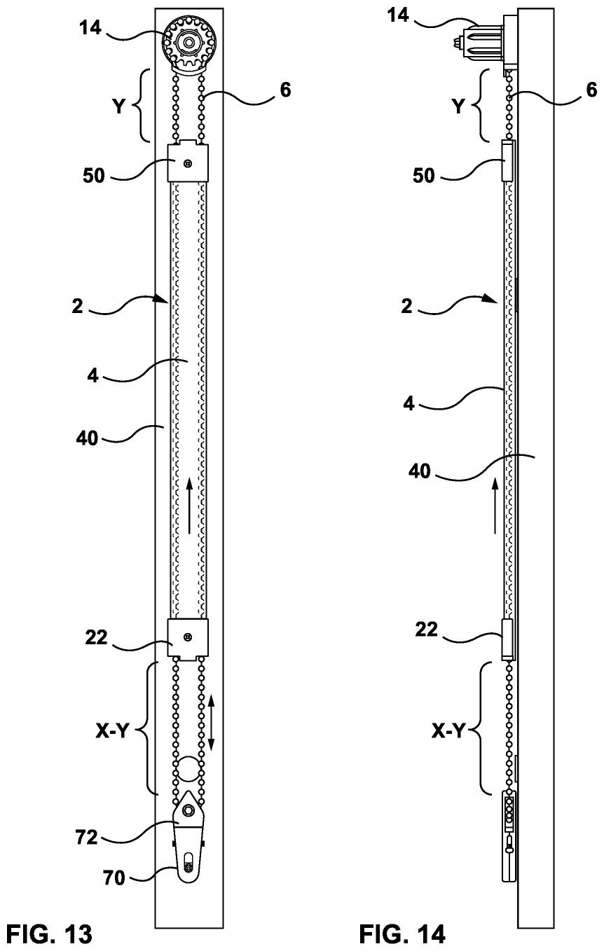

The wand 2 or elongated member 4 is shorter in length than the loop of endless blind control element 6 so that a length X of the endless loop blind control element is exposed above the guide 50 in the lower position shown in FIG. 4, while the same length X of the endless loop blind control element is exposed below the lower end 10 when the wand 2 is in the open position shown in FIG. 4. The wand 2 can be raised up to the total length X or alternatively the wand can be raised just a portion Y as shown in FIGS. 13 and 14 for example within the scope of this invention. In some jurisdictions such as Canada government authorities regulate the length of endless loop blind control element that can be exposed to protect children from accidental entanglement with the endless loop blind control element 6. In one embodiment X can be selected at 8 inches or 20 centimeters.

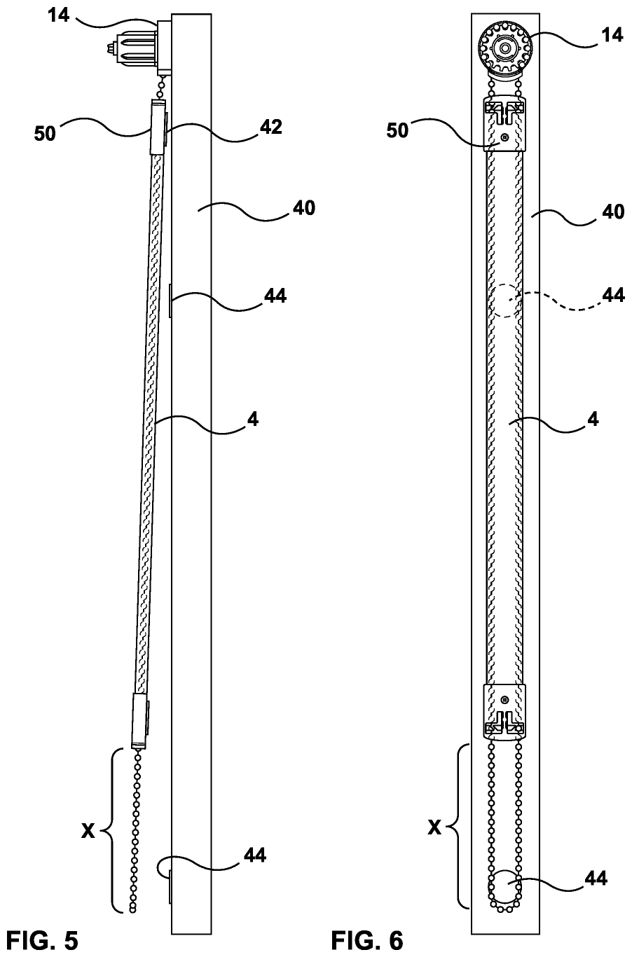

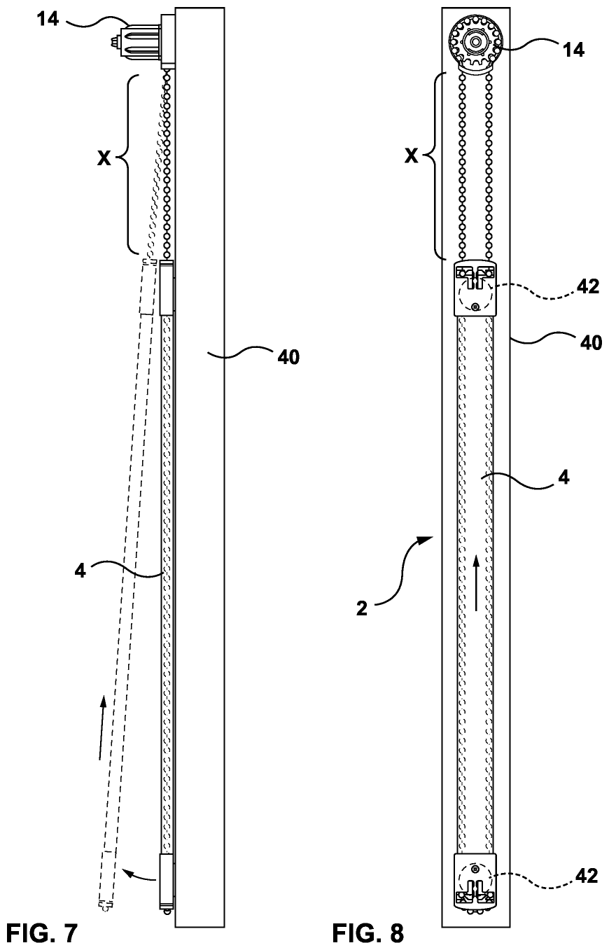

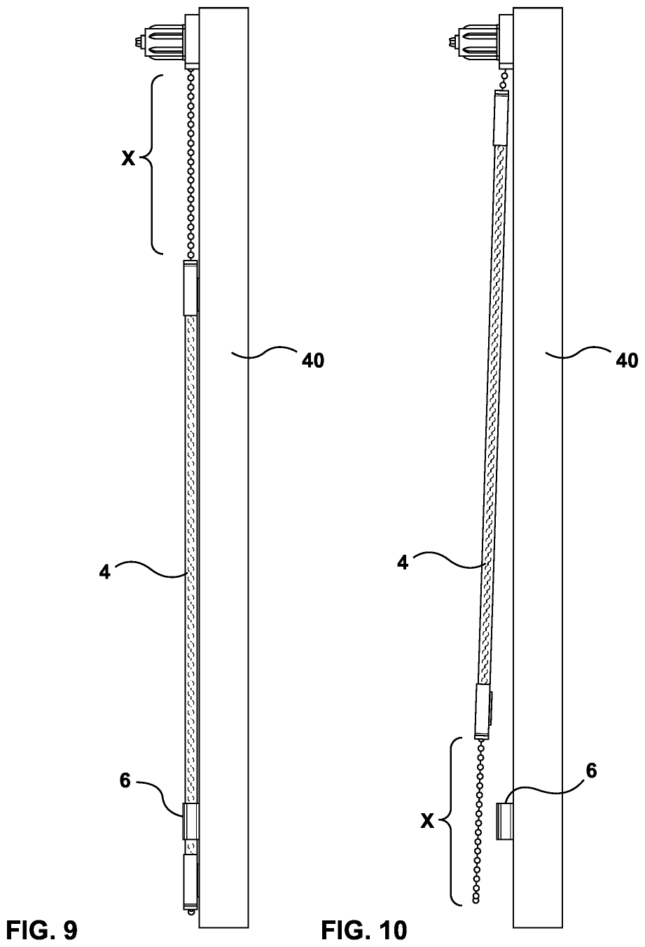

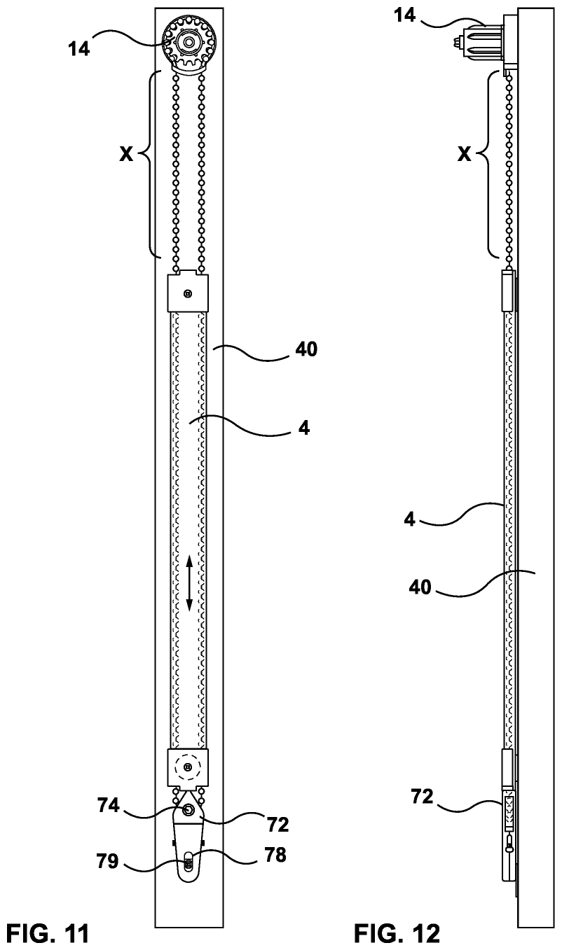

The wand 2 can be pulled or swung in any direction since the wand 2 freely hangs from the sprocket 2 or clutch assembly 14 as shown in FIGS. 4 and 5.

Alternatively the magnetic material 42 and magnetic metal 44 can be replaced by capturing device or retainer 60 such as a clip 60 for example which is attached to the frame 40. The outer periphery or surface of elongated member 4 can be pressed against the clip 60 to be removeably retained thereby. Then when the wand 2 is in use the wand 2 is pulled away from the clip 70 and then the wand 2 is manually moved to the open position and/or operable position the endless loop blind control element 6 is manually moved to rotate the socket 12 and raise or lower the window covering or fabric.

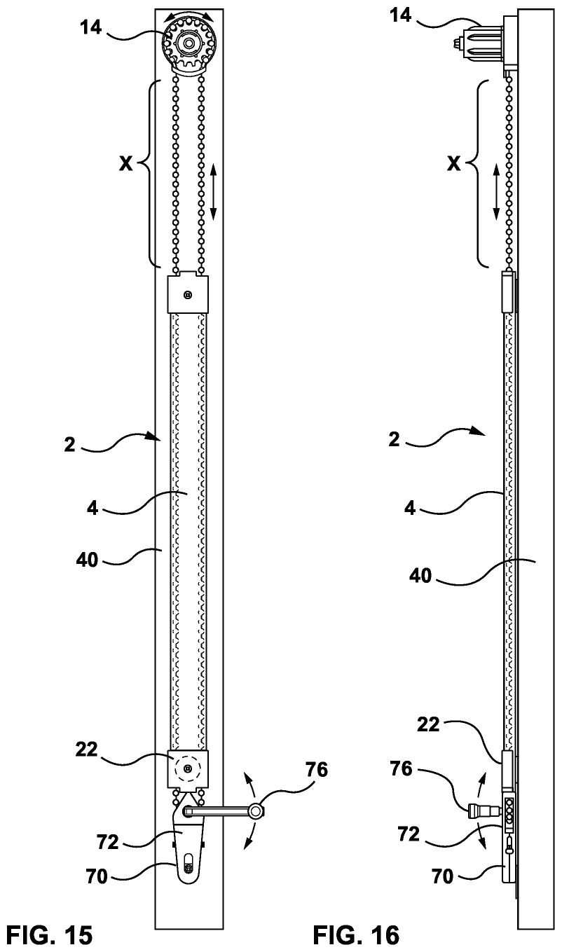

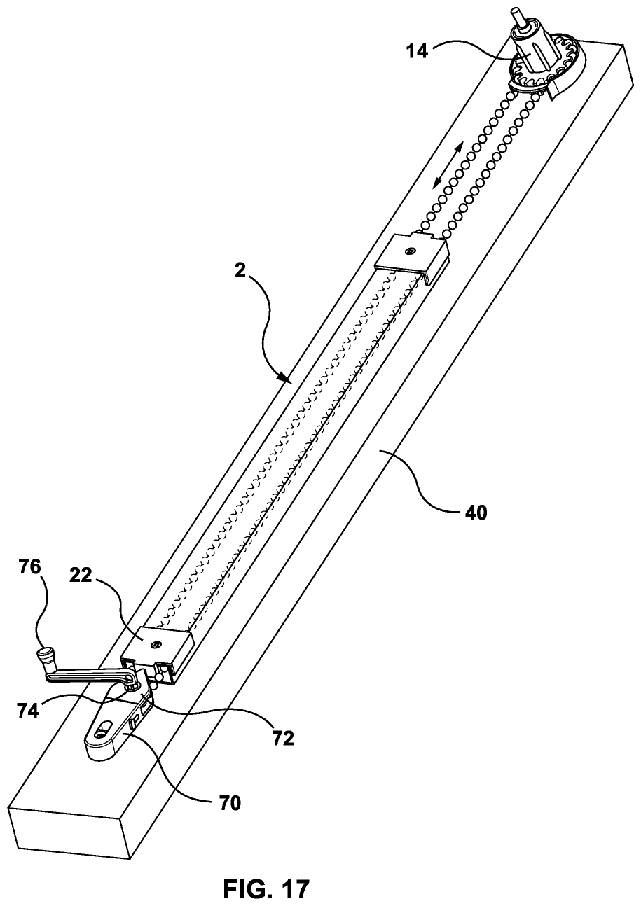

As a further alternative as shown in FIGS. 13-17 a tensioning device 70 can be attached to the frame 40 where the tensioning device 70 is traversed by the lower portion of the endless loop blind control element 6 to keep the endless loop blind control element 6 in tension. The tensioning device 70 includes a flap 72 that is moveable between an open position to insert the lower portion of the endless loop blind control element 6 into the tensioning device around a sprocket or pulley (not shown) located inside the tensioning device 70 and a closed position. The tensioning device 70 can include a socket opening 74 to engage with a hand crank 76 to rotate the endless loop blind control element 6. The tensioning device includes a slot 78 which accommodates a fastener 79 so as to fasten the tensioner 70 to the frame 40 by fastener 79 such as a screw 79. The fastener 70 includes the slot 78 so as to adjust the tension by moving the tensioner up or down along the slot 78.

The invention as described above illustrates a displaceable or moveable wand 2, comprising;
a) an elongated transparent tube 4 extending from an upper end 8 to a lower end 10;
b) an endless loop blind control element 6 disposed within said elongated transparent tube and extending beyond said upper and lower end;
c) an abutment 33 at said lower end 10 of said elongated transparent tube 4 extending through said endless loop blind control element 6 to permit said elongated transparent tube 4 to:
   i) hang from a lower end of said endless loop blind control element 6 and block access to said lower end of said endless loop blind control element 6 in a first position, and;
   ii) be raised to a second position to expose said lower end of said endless loop blind control element 6 and manually rotate said endless loop blind control element in said second operable position.

1. A displaceable wand, comprising; an elongated member extending from a first end to a second end, an endless loop blind control element disposed within said elongated member and extends beyond at least one of said first and second ends; and a restrictor presented at one of said first and second ends, said restrictor extending through said endless loop blind control element to permit said elongated member to:
a) hang from said endless loop blind control element and block access to said one end of said endless loop blind control element in a first position, and;
b) be raised to a second position to expose said one end of said endless loop blind control element and rotate said endless loop blind control element in said second position.

2. The displaceable wand as claimed in claim 1 wherein said first and second ends comprise an upper end and lower end respectively and said restrictor is positioned at said lower end.

3. The displaceable wand as claimed in claim 2 wherein said elongated member comprises a tube.

4. The displaceable wand as claimed in claim 3 wherein said tube is selected from the group having a rectangular, circular, oval, poly-sided and transparent cross section.

5. The displaceable wand as claimed in claim 3 wherein said endless loop blind control member hangs from a blind control adjacent said upper end of said tube.

6. The displaceable wand as claimed in claim 5 wherein said blind control includes either a sprocket, clutch or pulley and said endless loop blind control element hangs from said sprocket, clutch or pulley.

7. The displaceable wand as claimed in claim 5 wherein said restrictor is fastened to said lower end of said tube.

8. The displaceable wand as claimed in claim 6 wherein said restrictor has an open restrictor end having the same cross-section as the lower end of said tube and a transit end having two transit openings separated by an abutment to permit said endless loop blind control element to transit around the lower end of said wand.

9. The displaceable wand as claimed in claim 8 wherein said abutment has a curved surface extending beyond said lower end of said tube.

10. The displaceable wand as claimed in claim 8 wherein said wand includes a least one magnetic member disposed between said upper and lower ends of said tube; wherein said wand hangs substantially vertical to a window frame and said window frame includes a magnetic metal adjacent said magnetic member for magnetic attraction there between

11. The displaceable wand as claimed in 8 wherein said wand hangs substantially vertical to a window frame and said window frame includes a tensioning device traversed by a lower end of said endless loop blind control element to keep said endless loop blind control element in tension.

12. The displaceable wand as claimed in claim 11 wherein said tensioning device includes a flap that is moveable between an open position to insert said lower portion of said endless loop blind control element into said tensioning device and a closed position.

13. The displaceable wand as claimed in claim 12 wherein said tensioning device includes a socket opening to engage with a hand crank to rotate said endless loop blind control element.

14. The displaceable wand as claimed in claim 8 wherein said wand hangs substantially vertical to a window frame and said window frame includes a retaining means to retain said wand against said window frame in said vertical position.

15. The displaceable wand as claimed in claim 1 where up to 8 inches or 20 centimeters of said lower end of said endless loop blind control element is exposed in said second position.

16. The displaceable wand as claimed 10 wherein said tube includes a first magnetic member at said upper end and a second magnetic member at said upper end.

17. The displaceable wand as claimed in claim 2 including an upper guide presented at said upper end of said elongated member for guiding said endless loop blind control element.

18. The displaceable wand as claimed in claim 9 wherein said endless loop blind control element comprises a cord having spaced beads disposed along said cord and said curved surface is longer than the distance between said spaced beads.

19. The displaceable wand as claimed in claim 4 wherein said tube is rectangular in cross section and transparent.

20. A displaceable wand, comprising;
a) an elongated transparent tube extending from an upper end to a lower end;
b) an endless loop blind control element disposed within said transparent tube and extending beyond said upper and lower end of said elongated transparent tube;
c) an abutment at said lower end of said tube extending through said endless loop blind control element to permit said elongated transparent tube to:
i) hang from a lower end of said endless loop blind control element and block access to said lower end of said endless loop blind control element in a first position, and;
ii) be raised to a second position to expose said lower end of said endless loop blind control element and manually rotate said endless loop blind control element in said second position.
